(19) United States
(12) Patent Application Publication
(10) Pub. No.: US 2026/0186814 A1
(43) Pub. Date: Jul. 2, 2026

(54) DYNAMIC ON-DEMAND VIRTUAL PRIVATE NETWORK BROKERING FOR SOFTWARE ENDPOINT

(71) Applicant: Microsoft Technology Licensing, LLC, Redmond, WA (US)

(72) Inventors: Gregory Allen LUMEN, Kent, WA (US); Joseph Alexander LLOYD, Kent, WA (US)

(21) Appl. No.: 19/005,413

(22) Filed: Dec. 30, 2024

(51) Int. Cl. G06F 9/455; H04L 9/32

(52) U.S. Cl. CPC G06F 9/45558; H04L 9/32; G06F 2009/45587; G06F 2009/45595

(57) ABSTRACT

Various embodiments relate to a computer-implemented method involving a processor system for brokering dynamic workload-based virtual private network (VPN) connections. The method includes validating a first endpoint, which comprises a software workload executing on a remote computer system, by at least verifying a cryptographic credential associated with the software workload. Upon successful validation, the method initiates the establishment of a VPN connection between the first endpoint and a second endpoint. Following the establishment of the VPN connection, the method further initiates the destruction of the VPN connection between the first and second endpoints. This approach ensures secure and controlled VPN connectivity by validating software workloads and managing the lifecycle of VPN connections.

### BACKGROUND

Networking forms the backbone of modern digital communication, enabling the exchange of information between devices, systems, and users. At its core, networking relies on establishing connections through addressing schemes such as media access control (MAC) addresses and internet protocol (IP) addresses. These addresses define unique identifiers and routing pathways for the transmission of data packets. The efficient and reliable exchange of these packets ensures that information can flow seamlessly across networks, whether local, wide-area, or global, such as the Internet.

These foundational elements are structured within the open systems interconnection (OSI) model, a conceptual framework that defines how data is transmitted and received through various layers. The OSI model highlights the layered nature of networking, with lower layers—physical, data Link, and network—providing infrastructure for communication. The physical layer governs the transmission of raw bits across physical media, while the data link layer manages error detection and MAC-level addressing for local network segments. The network layer, encompassing IP addressing, establishes routing between devices over diverse and interconnected networks. While these layers establish the foundation for data movement, higher layers, such as transport and application layers, enable complex interactions like authentication, encryption, and session management. This hierarchical structure underscores that true authentication of users, devices, workloads, or data is implemented at higher layers, relying on the robust connectivity provided by the foundational layers. By building upon the lower layers, higher-level networking protocols and security mechanisms ensure trust and reliability within digital communications. Technologies like secure sockets layer (SSL), transport layer security (TLS), and application-level authentication leverage the underlying MAC and IP address-based routing to deliver secure, verified interactions.

In the context of secure networking, a site-to-site virtual private network (VPN) enables secure and encrypted communication between two or more geographically separated networks. A site-to-site VPN establishes a virtualized tunnel over the public Internet or other untrusted networks, ensuring that data transmitted between sites remains confidential, authenticated, and tamper-proof. The underlying mechanism of a site-to-site VPN relies heavily on the foundational OSI model layers. At the network layer, IPsec (Internet Protocol Security) is often employed to secure data in transit. IPsec operates by encrypting and authenticating packets, leveraging principles such as encapsulating security payloads (ESP) and authentication headers (AH). These mechanisms provide encryption to maintain data confidentiality and hashing to verify data integrity, ensuring that packets have not been altered during transit. The encapsulation process also facilitates secure routing by encapsulating private IP addresses within encrypted packets, shielding internal network structures from potential external threats. On a broader scale, the data link layer may play a role in creating a secure connection within a localized context, especially when combined with tunneling protocols such as Layer 2 Tunneling Protocol (L2TP). Site-to-site VPNs are implemented through dedicated VPN gateways—devices or software instances configured at the edge of participating networks. These gateways serve as the endpoints for the encrypted tunnels and handle encapsulation, encryption, decryption, and routing of VPN traffic.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: validating a first endpoint comprising a software workload executing at a remote computer system, including validating a cryptographic credential associated with the software workload; initiating an establishment of a virtual private network (VPN) connection between the first endpoint and a second endpoint, based on validating the software workload executing at the remote computer system; and subsequent to the establishment of the VPN connection between the first endpoint and the second endpoint, initiating a destruction of the VPN connection between the first endpoint and the second endpoint.

In some aspects, the techniques described herein relate to methods, systems, and computer program products, including: validating a first endpoint comprising a software workload executing at a remote computer system, including: validating a cryptographic credential associated with the software workload; and validating an attestation status of the software workload; initiating an establishment of a VPN connection between the first endpoint and a second endpoint, based on validating the software workload executing at the remote computer system; and subsequent to the establishment of the VPN connection between the first endpoint and the second endpoint, initiating a destruction of the VPN connection between the first endpoint and the second endpoint.

In some aspects, the techniques described herein relate to methods, systems, and computer program products, including: validating a first endpoint comprising a software workload executing at a remote computer system, including validating a cryptographic credential associated with the software workload, and validating an attestation status of the software workload; initiating an establishment of a VPN connection between the first endpoint and a second endpoint, based on validating the software workload executing at the remote computer system; detecting a change in the attestation status of the software workload; and initiating a destruction of the VPN connection between the first endpoint and the second endpoint based on the change in the attestation status of the software workload.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIGS. 1A and 1B illustrate an example of a network architecture for brokering a dynamic on-demand virtual private network (VPN) connection for a software endpoint;

FIGS. 2A and 2B illustrate an example of a network architecture for securely managing a packet route between endpoints in a zero-trust network;

FIG. 3 illustrates an example of a network architecture for routing between zero-trust networks;

FIG. 4 illustrates an example of a broker computer system for brokering dynamic on-demand VPN connections; and

FIG. 5 illustrates a flow chart of an example of a method for brokering a dynamic on-demand VPN connection for a software endpoint.

### DETAILED DESCRIPTION

In modern security paradigms, the “zero-trust” model builds upon a layered networking foundation, such as the Open Systems Interconnection (OSI) model, to address evolving cybersecurity challenges. Zero-trust principles include explicit verification based on all available data, such as user identity, device state, application type, and geographic location. The zero-trust model enforces least-privileged access by applying only the minimum trust necessary for any transaction or interaction. By assuming breach as a default stance, zero-trust principles advocate segmenting networks, users, devices, and applications to limit the scope of potential security incidents and mitigate risk.

Extending the zero-trust model, the embodiments described herein utilize site-to-site VPN technology and a trusted secure communication gateway to dynamically establish trust between endpoints, utilizing cryptographic software identity and software configuration attestation to ensure that given endpoints can communicate only under controlled circumstances. In particular, these embodiments utilize site-to-site VPN technology to broker data flows dynamically in a network in response to software application needs. Thus, rather than (or in addition to) using site-to-site VPN technology to enable secure and encrypted communication between networks, the embodiments herein can use site-to-site VPN technology to enable secure and encrypted communication between software entities.

While VPNs are traditionally used for broadly specified flows (such as a remote worker's computer to a corporate network), the embodiments described herein use the same underlying VPN technology in a micro-segmented pattern. This enables, for example, multiple individual software-based workloads (e.g., virtual machines, containers) to talk to multiple insecure data-producing devices, such as Internet of Things (IoT) devices. At the same time, no other workloads, computers, malware, or network skimmers can route packets past the secure communication gateway to discover the network presence of said insecure data-producing devices. This trust can be dynamic, where one workload can become untrusted (e.g., due to a loss of attestation) and removed from a site-to-site VPN, while dataflow can continue to another workload—even if those workloads are co-located on the same server.

In addition, some embodiments further modify the OSI model, and networking wholistically to use endpoint identity to affect the lowest layers of the network. Using these embodiments, instead of being implicit in the architecture of a network, specific network topologies, including routes between endpoints, exist only after those endpoints have been validated and approved to communicate with one another. In embodiments, these network topologies exist only in response to secure authenticated identity requests being made by secure software application code executing at an endpoint device. Thus, these embodiments decrease trust in the fundamental network, making the network dynamic and responsive to verifiable trust and explicit authorization. In one example, instead of a conventional network web with largely static routes between devices, a network appliance positioned between endpoint devices creates and destroys network routes between endpoints in response to instructions from an authority that authenticates and authorizes those endpoints, thereby dynamically altering the network topology like a valve controlling the flow of water. While endpoints can include any form of network-connected device, in one example, endpoints include “brownfield” devices (e.g., legacy equipment and legacy software that performs discrete functions in isolation and that are generally considered insecure) and more modern devices running secured workloads (e.g., containers, virtual machines, etc.). In these environments, the secured workloads can communicate with insecure brownfield IoT devices over specially created network routes between those secured workloads and IoT devices, while network sniffers, intruders, malware, and other data sinks would not even be able to route packets to these devices, since those network routes would not exist.

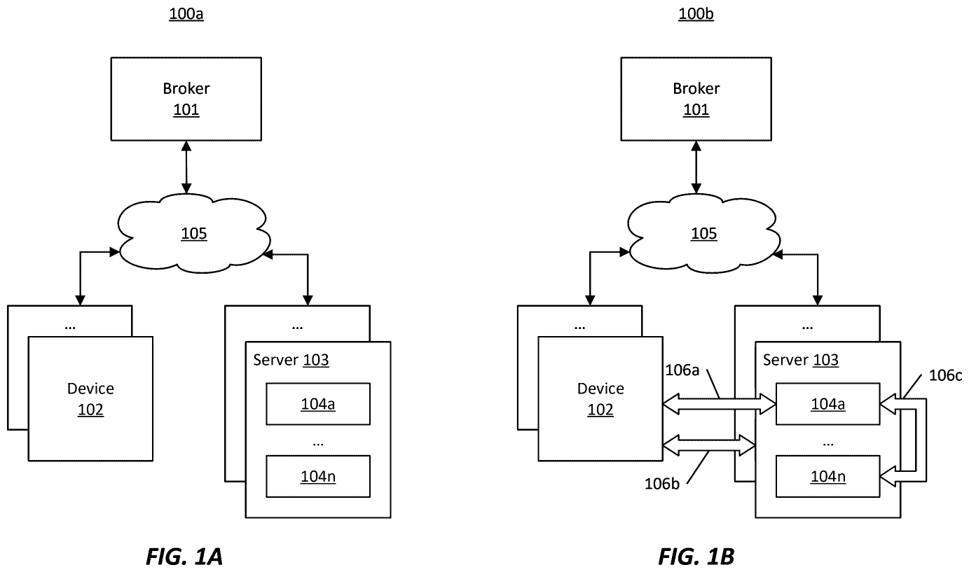

FIGS. 1A and 1B illustrate examples 100a and 100b, respectively, of a network architecture for brokering a dynamic on-demand VPN connection for a software endpoint. Referring initially to FIG. 1A, example 100a shows a plurality of devices (e.g., device 102, server 103) and a VPN broker (broker 101), all connected by a network 105 (e.g., one or more networks, such as a local-area network (LAN), and/or a wide-area network (WAN) such as the Internet). In embodiments, broker 101 manages the dynamic creation and destruction of on-demand VPN tunnels among endpoints within these network-connected devices. An ellipse associated with device 102 and an ellipse associated with server 103 indicates that the network architecture can include any number of devices and/or servers. Additionally, an ellipse associated with software entities 104a and 104n indicates that the network architecture can include any number of software entities, which can be distributed across devices/servers in any manner.

While typical VPN tunnels enable secure and encrypted communication between network endpoints (e.g., gateways, routers), the network architecture of example 100a extends the use of VPN technology to broker on-demand VPN tunnels having a software entity as at least one of the endpoints. Thus, in example 100a, broker 101 can broker VPN tunnels having devices as endpoints (e.g., device 102, such as an IoT device, smartphone, tablet computer, or personal computer; server 103). In example 100a, broker 101 can also broker VPN tunnels having software entities as endpoints (e.g., software entities 104a-104n operating at server 103). In example 100a, the software entities 104a-104n can comprise any software workload to which a VPN tunnel can be attached. Typically, a software entity would have an IP address associated therewith, separate from an IP address of the device (e.g., device 102, server 103) on which it operates. As examples, software entities may include standalone applications, container workloads (e.g., DOCKER workloads, KUBERNETES workloads), and virtual machines.

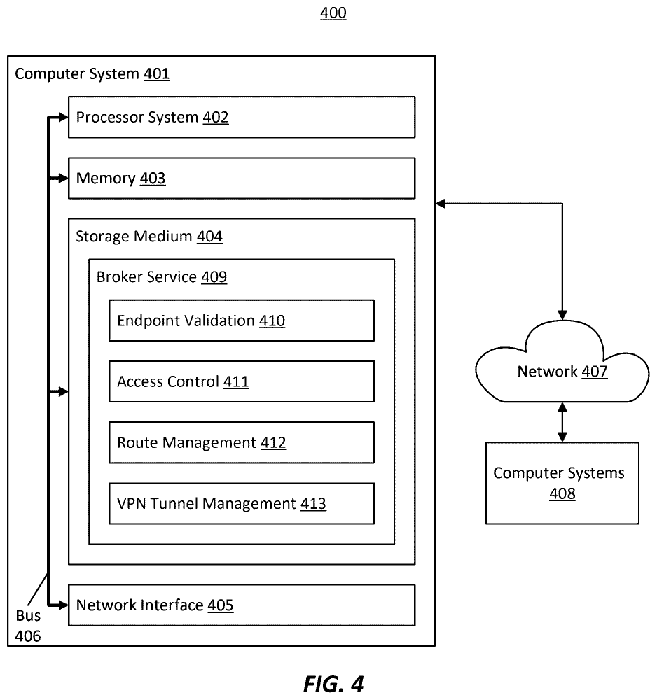

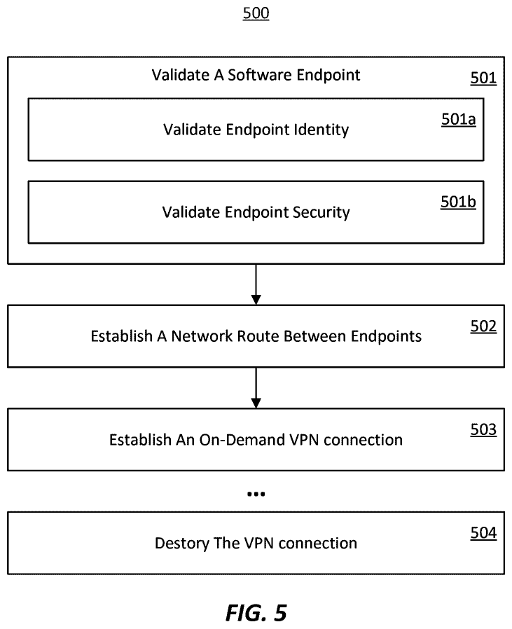

In embodiments, broker 101 operates upon a request from a requesting endpoint, such as a software entity, to form an on-demand VPN tunnel between the requesting endpoint and a destination endpoint. As will be described further in connection with FIGS. 4 and 5, in embodiments, broker 101 creates VPN tunnels between endpoints only under certain conditions—such as after validation of endpoint identity, endpoint security, and/or after communication permissions. Referring to FIG. 1B, example 100b illustrates examples of the types of VPN tunnels that broker 101 may form, including a VPN tunnel 106a between device 102 and software entity 104a (e.g., a device as one endpoint and a software entity as the other endpoint), a VPN tunnel 106b between device 102 and server 103 (e.g., devices as both endpoints), and VPN tunnel 106c between software entity 104a and entity 104n (e.g., software entities as both endpoints). Notably, while VPN tunnel 106c has software endpoints operating at the same device (server 103), other example VPN tunnels have software endpoints operating at different devices (e.g., different servers). In embodiments, broker 101 also destroys VPN tunnels—such as after a particular amount of time has elapsed, after the completion of a communication session, or after the loss of an endpoint security status (e.g., a loss of attestation).

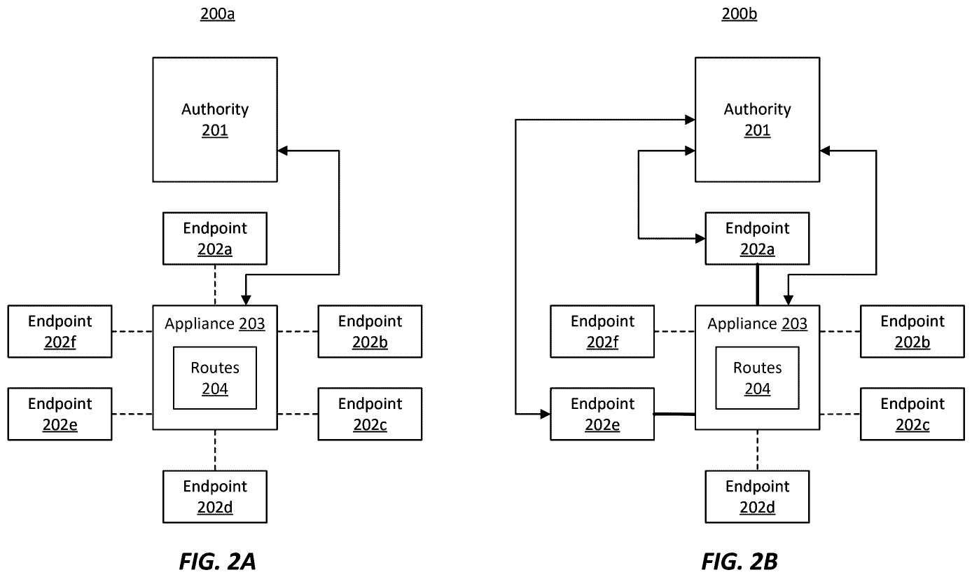

As mentioned, some embodiments further use endpoint identity to affect the lowest layers of the network. Using these embodiments, instead of being implicit in the architecture of a network, specific network topologies, including routes between endpoints, exist only after those endpoints have been validated and approved to communicate with one another. FIGS. 2A and 2B illustrate examples 200a and 200b, respectively, of a network architecture for securely managing a packet route between endpoints in a zero-trust network. Referring initially to FIG. 2A, example 200a shows a network including a plurality of endpoints (e.g., endpoint 202a-202f, though embodiments can operate in networks comprising any number of endpoints) and an appliance 203 that manages routes 204 among the endpoints. Each endpoint can comprise any form of network-connected entity, such as a physical device (e.g., IoT device, smartphone, tablet computer, server, personal computer) or a workload (e.g., virtual machine, container) that is assigned an internet protocol (IP) address. In embodiments, endpoints 202a-202f may correspond to the devices and software entities of examples 100a and 100b (e.g., device 102, server 103, software entities 104a-104n). Dashed lines in example 200a represent physical and/or logical network infrastructure that would enable communication (e.g., the exchange of network packets) between any two given endpoints. In example 200a, appliance 203 is illustrated as connected to each of these dashed lines, indicating that appliance 203 manages the use of this network infrastructure by endpoints. In various examples, appliance 203 includes, or manages, one or more of a network router, a network switch, a network gateway, and the like.

While the dashed lines in example 200a represent the presence of a network infrastructure that enables communication among the endpoints, in embodiments, appliance 203 manages routes 204 in a manner that prevents network packet routing over that network infrastructure among endpoints as a default state. Thus, while physical infrastructure (e.g., wires, wireless interfaces) exists to enable communication between endpoints (e.g., endpoint 202a and endpoint 202e in one example), in embodiments, appliance 203 ensures that—as a default state—no route exits in routes 204 (e.g., via routing table(s), via network switch state) that would permit the routing of network packets between those endpoints.

Example 200a also includes an authority 201 that interoperates with appliance 203 (e.g., as indicated by an arrow that connects authority 201 and appliance 203) to create routes between particular endpoints under certain conditions—such as after validation of endpoint identity, after validation of endpoint security, and/or after validation of communication permissions. In some embodiments, authority 201 and broker 101 are the same system. In other embodiments, authority 201 and broker 101 are distinct systems that interoperate with one another. Referring to FIG. 2B, example 200b shows the network of example 200a after authority 201 (which may be broker 101) has interoperated with appliance 203 to establish a packet route between endpoint 202a and endpoint 202e. This packet route is indicated by solid lines that connect endpoint 202a and endpoint 202e with appliance 203. In embodiments, authority 201 (which may be broker 101) also interoperates with appliance 203 to destroy those routes—such as after a particular amount of time has elapsed, after the completion of a communication session, or after the loss of an endpoint security status.

The manner of route creation/destruction can vary depending on network infrastructure and implementation. Some examples include modifying lower-level OSI layers, such as modifying a routing table, modifying a network switch configuration, etc. In embodiments, routing refers to lower-level routing through specific port assignments, routing table entries, etc., independent of the underlying physical network connections. Additionally, or alternatively, in embodiments, routing is distinguished from a higher-level logical concept of packet direction by a networking device (e.g., which may be driven by optimization algorithms that can be influenced by various factors, such as administrative policies, network conditions, or security requirements). Additionally, while some embodiments utilize existing routing protocols and routing paradigms (e.g., IP/MAC address and port-based routing), others may utilize routing protocols and paradigms that do not yet exist. Examples include the use of routing paradigms in which the physical device moves from “port” to “port” over time (e.g., a satellite routing protocol that sends a packet to a port that relates to the physical position of radio frequency antennae array based on time of day), or where there is some other physical or software abstraction phenomenon.

In embodiments, broker 101/authority 201 establishes a VPN tunnel/route between two given endpoints based on communications with those endpoints. Thus, for example, example 200b uses double-ended arrows to illustrate communication between endpoint 202e and authority 201, and between endpoint 202a and authority 201. In embodiments, even though appliance 203 utilizes a policy of ensuring no routing between endpoints as a default state, appliance 203 does create routes between the endpoints and authority 201 by default, thereby enabling these communications between the endpoints and authority 201.

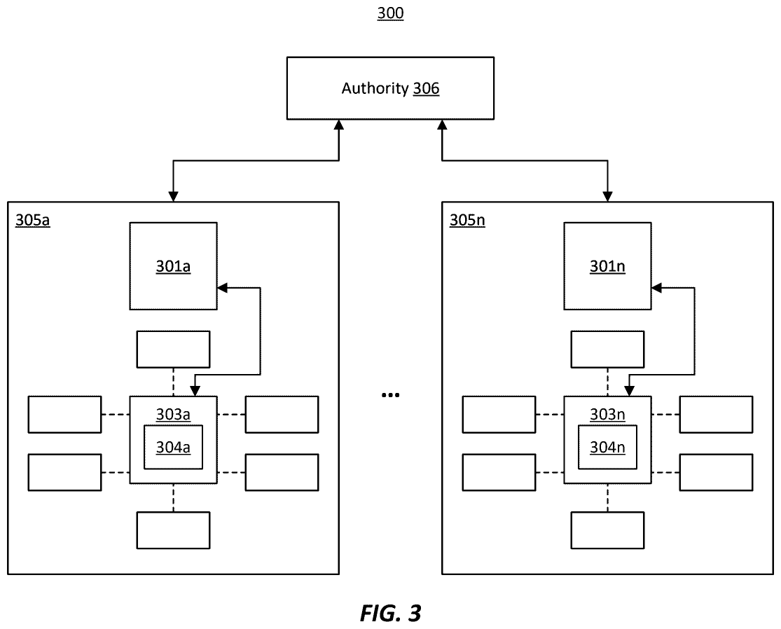

In some embodiments, broker 101 and/or authority 201 is a local (e.g., on-premises) authority over a local network and thereby manages the creation and destruction of VPN tunnels and/or routes between endpoints within that local network. In other embodiments, broker 101 and/or authority 201 is an authority over endpoints in a plurality of networks and thereby manages the creation and destruction of routes between endpoints across those networks. For example, FIG. 3 illustrates an example 300 of a network architecture for routing between zero-trust networks. In example 300, an authority 306 (e.g., a central authority) is responsible for authenticating endpoints among a plurality of networks, such as network 305a to network 305n. In some examples, authority 306 is a singular authority that communicates directly with endpoints and network appliances. In other embodiments, authority 306 interoperates with local authorities. In example 300, for instance, each of network 305a and network 305n includes its own local authority (e.g., authority 301a in network 305a, authority 301n in network 305n) and network appliance (e.g., appliance 303a managing routes 304a in network 305a, appliance 303n managing routes 304n in network 305n). Here, endpoints in a given network communicate their local authority, which in turn communicates with authority 306. Hybrid architectures are also possible, e.g., in which one local network includes its own local authority that interoperates with authority 306 on behalf of endpoints and in which another local network lacks a local authority, and its endpoints interoperate directly with authority 306.

FIG. 4 illustrates an example 400 of a broker computer system 401 for brokering dynamic on-demand VPN connections. In various examples, broker computer system 401 corresponds to broker 101, authority 201, authority 301a, authority 301n, or authority 306. As shown, broker computer system 401 comprises a processor system 402 (e.g., a single processor or a plurality of processors), a memory 403 (e.g., system or main memory), a storage medium 404 (e.g., a single computer-readable storage medium, or a plurality of computer-readable storage media), and a network interface 405 (e.g., one or more network interface cards), all interconnected by a bus 406. Using network interface 405, broker computer system 401 interconnects via network 407 to computer systems 408 (e.g., a single computer system or a plurality of computer systems, such as device 102, server 103, endpoints 202a-202f, and/or appliance 203).

In example 400, the storage medium 404 stores computer-executable instructions implementing a broker service 409, which includes an endpoint validation component 410, an access control component 411, a route management component (route component 412), and a VPN tunnel management component (tunnel component 413). In embodiments, the operation of the broker service 409 is triggered by a request from a software endpoint, such as one of device 102, server 103, or endpoints 202a-202f.

The endpoint validation component 410 validates an endpoint making a request of the broker computer system 401. The particular manner of endpoint validation can vary, and in environments, it includes one or more of an endpoint identity validation or an endpoint security validation. Notably, there could be an overlap between the identity validation and security validation. For example, validating the security status of an endpoint may inherently include validating the identity of the endpoint.

Regarding endpoint identity validation, the manner of endpoint identity validation can range from simple (and typically less secure) to advanced (and more typically secure). For example, on the simpler end of the spectrum, identity validation may include validating that the IP address used by a device or workload matches an expected media access control (MAC) address for the device/workload. This may be useful, for example, for validating legacy devices, such as brownfield IoT devices. In another example, on the more advanced end of the spectrum, identity validation may include validating the authenticity and current validity of a cryptographic certificate presented by a device/workload. This may be useful, for example, for validating devices having a modern operating system (OS) and for validating workload-based endpoints such as virtual machines, containers, and the like. In embodiments, endpoint validation component 410 could perform a single type of identity validation for a given endpoint or could perform multiple types of identity validation for a given endpoint.

Regarding endpoint security validation, the particular manner of security validation can also vary from simple (and less secure) to advanced (and more secure). For example, on the simpler end of the spectrum, security validation may include validating that specific ports are closed on the endpoint's IP address or validating a version of software associated with the endpoint. On the more advanced end of the spectrum, security validation may include obtaining an attestation certificate issued based on one or more claims provided by the endpoint (e.g., with those claims being based on one or more trusted platform module (TPM) keys at the endpoint, based on a secure boot status of the endpoint, and based on software installed or absent from the endpoint). In one example of attestation-based security validation, the endpoint validation component 410 receives one or more claims from an endpoint and then operates as an attestation service to validate those claims and issue an attestation certificate to the endpoint. In another example of attestation-based security validation, the endpoint validation component 410 receives one or more claims from an endpoint, sends those claims to a separate attestation service, and receives an attestation certificate from the separate attestation service.

In some embodiments, endpoints occasionally request validation by the broker service 409, preparing a given endpoint for communication with other endpoints when needed. For example, an endpoint may request validation every hour, every 12 hours, every 24 hours, etc. In this example, endpoint validation component 410 may issue a certificate (e.g., an attestation certificate) valid for an hour, 12 hours, 24 hours, etc., to the endpoint. In some instances, the endpoint validation component 410 may operate responsive to a validation request by an endpoint separate from a communication request from the endpoint. In other instances, the endpoint validation component 410 may operate responsive to a communication request from an endpoint.

Based on an endpoint initiating a communication request, the access control component 411 determines if endpoints are authorized to communicate. For example, the access control component 411 may operate based on rules that explicitly authorize/deny communications between certain sets of endpoints, the access control component 411 may operate based on rules that authorize/deny communications between certain classes of endpoints, and/or the access control component 411 may operate based on rules that authorize/deny communications based on credentials (e.g., cryptographic keys, cryptographic certificates) possessed by different endpoints.

Based on the operation of endpoint validation component 410 and access control component 411, broker service 409 may create a VPN tunnel between endpoints. For example, in embodiments, broker service 409 initiates the creation of a VPN tunnel between two endpoints when each of those endpoints has been validated (endpoint validation component 410) and/or when those endpoints are determined to be authorized to communicate (access control component 411).

As described in connection with FIGS. 2A-2B, in addition to establishing dynamic on-demand VPN tunnels, some embodiments also dynamically create and destroy network routes. In these embodiments, route component 412 initiates the creation of a route between two endpoints before creating a VPN tunnel. In some implementations, route component 412 creates routes directly (e.g., broker 101/authority 201 may be integrated into appliance 203). In other implementations, route component 412 communicates with a network appliance, such as appliance 203, to instruct the appliance to create routes.

As also described, some embodiments operate on the principle of ensuring no routing between endpoints by default. In some embodiments, this means that route component 412 also initiates the destruction of a route. Thus, route component 412 determines when an established route should no longer exist and initiates the destruction of that route. In various examples, route component 412 initiates the destruction of a route between two given endpoints after a defined amount has elapsed since the route's creation, after the conclusion of a communication session between the route's endpoints, or when a security state of one of the route's endpoints has changed (e.g., when an endpoint loses attestation due to expiration of a certificate or a change in software state at the endpoint).

Regardless of whether or not dynamic route creation/destruction is used, tunnel component 413 initiates the creation of a VPN tunnel between two endpoints. In embodiments, this VPN tunnel may utilize a route created by route component 412. In some implementations, tunnel component 413 creates VPN tunnels directly. In other implementations, tunnel component 413 communicates with a network appliance, such as appliance 203, to instruct the appliance to create VPN tunnels.

Similarly to route component 412 destroying a route, in embodiments, tunnel component 413 also initiates the destruction of a VPN tunnel. Thus, tunnel component 413 determines when an established VPN tunnel should no longer exist and initiates the destruction of that VPN tunnel. In various examples, tunnel component 413 initiates the destruction of a VPN tunnel between two given endpoints after a defined amount has elapsed since the tunnel's creation, after the conclusion of a communication session between the tunnel's endpoints, or when a security state of one of the tunnel's endpoints has changed (e.g., when an endpoint loses attestation due to expiration of a certificate or a change in software state at the endpoint).

In some embodiments, the broker service 409 facilitates endpoint discovery and/or facilitates endpoint authentication. For example, referring to FIG. 1B, software entity 104a (e.g., a container workload) needs to send data to device 102 (e.g., an IoT device). However, software entity 104a may be unaware of device 102 altogether or be unaware of details of device 102—such as the IP address of device 102. In embodiments, when software entity 104a sends a communication request to broker 101, broker 101 identifies the appropriate endpoint for communication and sends appropriate addressing information (e.g., an IP address of device 102) to software entity 104a. In additional or alternative embodiments, broker 101 may send software entity 104a and/or device 102 information needed to establish or authenticate a network connection with the other endpoint. Such information may include, for example, an attestation certificate of the other endpoint or a public key of the other endpoint.

Operation of the broker service 409 is now described in connection with FIG. 5, which illustrates a flow chart of an example method 500 for brokering a dynamic on-demand VPN connection for a software endpoint. In embodiments, instructions for implementing method 500 are encoded as computer-executable instructions (e.g., broker service 409) stored on a computer storage medium (e.g., storage medium 404) that are executable by a processor (e.g., processor system 402) to cause a computer system (e.g., broker computer system 401) to perform method 500.

The following discussion now refers to a method and method acts. Although the method acts are discussed in specific orders or are illustrated in a flow chart as occurring in a particular order, no order is required unless expressly stated or required because an act is dependent on another act being completed before the act is performed.

Referring to FIG. 5, in embodiments, method 500 comprises act 501 of validating a software endpoint. In some embodiments, act 501 includes validating a first endpoint comprising a software workload executing at a remote computer system. For example, based on a request from software entity 104a to connect to device 102, endpoint validation component 410 operating at broker 101 validates software entity 104a. In some examples, software entity 104a may be a container or virtual machine.

Act 501 is illustrated as including act 501a of validating endpoint identity and/or act 501b of validating endpoint security. In some examples, act 501a comprises validating a cryptographic credential associated with the software workload. For example, the endpoint validation component 410 validates an identity of software entity 104a based on a cryptographic credential (e.g., certificate or public key) received from software entity 104a. In some examples, act 501b comprises validating an attestation status of the software workload. For example, endpoint validation component 410 may attest the software entity 104a and issue an attestation certificate to the software entity 104a or may validate an attestation certificate received from the software entity 104a.

In general, method 500 can comprise validating the identity and/or security status of any number of endpoints any number of times. For example, in some instances, endpoints may initiate identity and/or security validation on a cadence, such as every hour, every 12 hours, or every 24 hours. Thus, in embodiments of act 501, the identity is a first identity, and the cryptographic credential is a first cryptographic credential, and method 500 further comprises validating a second identity of the second remote endpoint based on a second cryptographic credential received from the second remote endpoint. For example, the endpoint validation component 410 also validates an identity of device 102, server 103, software entity 104n, etc. (e.g., before or after validating the identity of software entity 104a in act 501).

In some embodiments, method 500 also comprises authorizing endpoint communication, such as by determining that the first endpoint is authorized to communicate with a second endpoint and/or determining that the second endpoint is authorized to communicate with the first endpoint. For example, the access control component 411 uses one or more rules (e.g., based on endpoint identity, endpoint class, and/or credentials possessed by the endpoints) to determine that software entity 104a and device 102 are authorized to communicate with each other.

In some embodiments, method 500 also comprises act 502 of establishing a network route between endpoints. In some embodiments, act 502 comprises initiating the establishment of a network packet route between the first endpoint and the second endpoint before initiating the establishment of the VPN connection between the first endpoint and the second endpoint. For example, based on validating software entity 104a and device 102, route component 412 establishes a route between those endpoints. In one example, initiating the establishment of the network packet route between the first endpoint and the second endpoint comprises initiating the establishment of a routing entry within a network routing table.

Regardless of the presence or absence of act 502, method 500 also comprises act 503 of establishing an on-demand dynamic VPN connection. In some embodiments, act 503 includes initiating an establishment of a VPN connection between the first endpoint and a second endpoint, based on validating the software workload executing at the remote computer system. For example, tunnel component 413 initiates the establishment of VPN tunnel 106a between device 102 and software entity 104a. Notably, unlike conventional VPN tunnels, at least one of these endpoints (e.g., software entity 104a) is a software entity rather than a network device. Thus, while conventional VPN tunnels are between devices, in the embodiments herein, VPN tunnels may be between software workloads (at the same computer system or different computer systems) or between a software workload and a hardware device, among other things.

Because embodiments operate on the principle of zero-trust, method 500 also comprises act 504 of destroying the VPN connection. In some embodiments, act 503 comprises, subsequent to establishing the VPN connection between the first endpoint and the second endpoint, initiating a destruction of the VPN connection between the first endpoint and the second endpoint. For example, tunnel component 413 destroys the VPN tunnel 106a between software entity 104a and device 102 that was established in act 503.

An ellipse between act 503 and act 504 indicates that the destruction of a VPN tunnel may not be a direct result of the creation of a VPN tunnel but rather due to some other factor, such as the passage of time, the competition of a communications session, or a change in endpoint security status. Thus, in embodiments of act 504, initiating the destruction of the VPN connection between the first endpoint and the second endpoint is based on at least one of the completion of a communication between the first endpoint and the second endpoint, elapsing of a predetermined amount of time, or a change in a security status of the first endpoint or the second endpoint. In embodiments, the VPN tunnel destruction is based on the change in the security status of the first endpoint or the second endpoint, and the change in the security status is a loss of attestation of the first endpoint or the second endpoint (e.g., due to the expiration of an endpoint's attestation certificate, or due to a change in software state at the endpoint).

Some embodiments of broker service 409 include robust logging and auditing capabilities. Thus, for example, embodiments may include logging the initiating the VPN connection between the first endpoint and the second endpoint and/or logging the initiating the destruction of the VPN connection between the first endpoint and the second endpoint.

Accordingly, embodiments relate to a computer-implemented method involving a processor system for brokering dynamic workload-based VPN connections. The method includes validating a first endpoint, which comprises a software workload executing on a remote computer system, by at least verifying a cryptographic credential associated with the software workload. Upon successful validation, the method establishes a VPN connection between the first endpoint and a second endpoint. Following establishing the VPN connection, the method further initiates the destruction of the VPN connection between the first and second endpoints. This approach ensures secure and controlled VPN connectivity by validating software workloads and managing the lifecycle of VPN connections.

Alternatively or in addition to the other examples described herein, examples include any combination of the following:

Clause 1. A method implemented in a computer system that includes a processor system, comprising: validating a first endpoint comprising a software workload executing at a remote computer system, including validating a cryptographic credential associated with the software workload; initiating an establishment of a virtual private network (VPN) connection between the first endpoint and a second endpoint, based on validating the software workload executing at the remote computer system; and subsequent to the establishment of the VPN connection between the first endpoint and the second endpoint, initiating a destruction of the VPN connection between the first endpoint and the second endpoint.

Clause 2. The method of clause 1, wherein the software workload is a container or virtual machine.

Clause 3. The method of any of clause 1 or claim 2, wherein the VPN connection is a site-to-site VPN connection.

Clause 4. The method of any of clause 1 to claim 3, wherein validating the first endpoint also includes validating an attestation status of the software workload.

Clause 5. The method of any of clause 1 to claim 4, wherein initiating the destruction of the VPN connection between the first endpoint and the second endpoint is based on at least one of: a completion of a communication between the first endpoint and the second endpoint; an elapsing of a predetermined amount of time; or a change in a security status of the first endpoint or the second endpoint.

Clause 6. The method of clause 5, wherein initiating the destruction of the VPN connection between the first endpoint and the second endpoint is based on the change in the security status of the first endpoint or the second endpoint, and wherein the change in the security status is a loss of attestation of the first endpoint or the second endpoint.

Clause 7. The method of any of clause 1 to claim 6, wherein the method further comprises logging at least one of: initiating the VPN connection between the first endpoint and the second endpoint; or initiating the destruction of the VPN connection between the first endpoint and the second endpoint.

Clause 8. The method of any of clause 1 to claim 7, wherein the second endpoint is a hardware device.

Clause 9. The method of any of clause 1 to claim 7, wherein: the software workload is a first software workload; and the second endpoint is a second software workload.

Clause 10. The method of clause 9, wherein the second software workload also executes at the remote computer system.

Clause 11. The method of any of clause 1 to claim 10, wherein: the method further comprises initiating an establishment of a network packet route between the first endpoint and the second endpoint before initiating the establishment of the VPN connection between the first endpoint and the second endpoint; and the VPN connection communicates network packets along the network packet route.

Clause 12. The method of clause 11, wherein initiating the establishment of the network packet route between the first endpoint and the second endpoint comprises initiating an establishment of a routing entry within a network routing table.

Clause 13. A computer system, comprising: a processor system; and a computer storage medium that stores computer-executable instructions that are executable by the processor system to at least: validate a first endpoint comprising a software workload executing at a remote computer system, including: validating a cryptographic credential associated with the software workload; and validating an attestation status of the software workload; initiate an establishment of a virtual private network (VPN) connection between the first endpoint and a second endpoint, based on validating the software workload executing at the remote computer system; and subsequent to the establishment of the VPN connection between the first endpoint and the second endpoint, initiate a destruction of the VPN connection between the first endpoint and the second endpoint.

Clause 14. The computer system of clause 13, wherein the software workload is a container or virtual machine.

Clause 15. The computer system of any of clause 13 or claim 14, wherein the second endpoint is a hardware device.

Clause 16. The computer system of any of clause 13 or claim 14, wherein: the software workload is a first software workload; and the second endpoint is a second software workload.

Clause 17. The computer system of any of clause 13 to claim 16, wherein initiating the destruction of the VPN connection between the first endpoint and the second endpoint is based on at least one of: a completion of a communication between the first endpoint and the second endpoint; an elapsing of a predetermined amount of time; or a change in a security status of the first endpoint or the second endpoint.

Clause 18. The computer system of any of clause 13 to claim 17, wherein: the computer-executable instructions are also executable by the processor system to initiate an establishment of a network packet route between the first endpoint and the second endpoint before initiating the establishment of the VPN connection between the first endpoint and the second endpoint; and the VPN connection communicates network packets along the network packet route.

Clause 19. The computer system of clause 18, wherein initiating the establishment of the network packet route between the first endpoint and the second endpoint comprises initiating an establishment of a routing entry within a network routing table.

Clause 20. A computer storage medium that stores computer-executable instructions that are executable by a processor system to at least: validate a first endpoint comprising a software workload executing at a remote computer system, including: validating a cryptographic credential associated with the software workload; and validating an attestation status of the software workload; initiate an establishment of a virtual private network (VPN) connection between the first endpoint and a second endpoint, based on validating the software workload executing at the remote computer system; detect a change in the attestation status of the software workload; and initiate a destruction of the VPN connection between the first endpoint and the second endpoint based on the change in the attestation status of the software workload.

Embodiments of the disclosure comprise or utilize a special-purpose or general-purpose computer system (e.g., broker computer system 401) that includes computer hardware, such as, for example, a processor system (e.g., processor system 402) and system memory (e.g., memory 403), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 404). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 405) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system that includes a processor system, comprising:
validating a first endpoint comprising a software workload executing at a remote computer system, including validating a cryptographic credential associated with the software workload;
initiating an establishment of a virtual private network (VPN) connection between the first endpoint and a second endpoint, based on validating the software workload executing at the remote computer system; and
subsequent to the establishment of the VPN connection between the first endpoint and the second endpoint, initiating a destruction of the VPN connection between the first endpoint and the second endpoint.

2. The method of claim 1, wherein the software workload is a container or virtual machine.

3. The method of claim 1, wherein the VPN connection is a site-to-site VPN connection.

4. The method of claim 1, wherein validating the first endpoint also includes validating an attestation status of the software workload.

5. The method of claim 1, wherein initiating the destruction of the VPN connection between the first endpoint and the second endpoint is based on at least one of:
a completion of a communication between the first endpoint and the second endpoint;
an elapsing of a predetermined amount of time; or
a change in a security status of the first endpoint or the second endpoint.

6. The method of claim 5, wherein initiating the destruction of the VPN connection between the first endpoint and the second endpoint is based on the change in the security status of the first endpoint or the second endpoint, and wherein the change in the security status is a loss of attestation of the first endpoint or the second endpoint.

7. The method of claim 1, wherein the method further comprises logging at least one of:
initiating the VPN connection between the first endpoint and the second endpoint; or
initiating the destruction of the VPN connection between the first endpoint and the second endpoint.

8. The method of claim 1, wherein the second endpoint is a hardware device.

9. The method of claim 1, wherein:
the software workload is a first software workload; and
the second endpoint is a second software workload.

10. The method of claim 9, wherein the second software workload also executes at the remote computer system.

11. The method of claim 1, wherein:
the method further comprises initiating an establishment of a network packet route between the first endpoint and the second endpoint before initiating the establishment of the VPN connection between the first endpoint and the second endpoint; and
the VPN connection communicates network packets along the network packet route.

12. The method of claim 11, wherein initiating the establishment of the network packet route between the first endpoint and the second endpoint comprises initiating an establishment of a routing entry within a network routing table.

13. A computer system, comprising:
a processor system; and
a computer storage medium that stores computer-executable instructions that are executable by the processor system to at least:
validate a first endpoint comprising a software workload executing at a remote computer system, including:
validating a cryptographic credential associated with the software workload; and
validating an attestation status of the software workload;
initiate an establishment of a virtual private network (VPN) connection between the first endpoint and a second endpoint, based on validating the software workload executing at the remote computer system; and
subsequent to the establishment of the VPN connection between the first endpoint and the second endpoint, initiate a destruction of the VPN connection between the first endpoint and the second endpoint.

14. The computer system of claim 13, wherein the software workload is a container or virtual machine.

15. The computer system of claim 13, wherein the second endpoint is a hardware device.

16. The computer system of claim 13, wherein:
the software workload is a first software workload; and
the second endpoint is a second software workload.

17. The computer system of claim 13, wherein initiating the destruction of the VPN connection between the first endpoint and the second endpoint is based on at least one of:
a completion of a communication between the first endpoint and the second endpoint;
an elapsing of a predetermined amount of time; or
a change in a security status of the first endpoint or the second endpoint.

18. The computer system of claim 13, wherein:
the computer-executable instructions are also executable by the processor system to initiate an establishment of a network packet route between the first endpoint and the second endpoint before initiating the establishment of the VPN connection between the first endpoint and the second endpoint; and
the VPN connection communicates network packets along the network packet route.

19. The computer system of claim 18, wherein initiating the establishment of the network packet route between the first endpoint and the second endpoint comprises initiating an establishment of a routing entry within a network routing table.

20. A computer storage medium that stores computer-executable instructions that are executable by a processor system to at least:
validate a first endpoint comprising a software workload executing at a remote computer system, including:
validating a cryptographic credential associated with the software workload; and
validating an attestation status of the software workload;
initiate an establishment of a virtual private network (VPN) connection between the first endpoint and a second endpoint, based on validating the software workload executing at the remote computer system;
detect a change in the attestation status of the software workload; and
initiate a destruction of the VPN connection between the first endpoint and the second endpoint based on the change in the attestation status of the software workload.
